(19) United States
(12) Patent Application Publication
(10) Pub. No.: US 2012/0310374 A1
(43) Pub. Date: Dec. 6, 2012

(54) METHOD AND APPARATUS FOR BEHAVIORISTIC-FORMAT CODING OF QUALITATIVE ANALOG DATA/DISTRIBUTED AUTOMATION PROTOCOL

(76) Inventor: Michael ABERSON, Haifa (IL)

(21) Appl. No.: 13/251,305

(22) Filed: Oct. 3, 2011

Related U.S. Application Data
(63) Continuation-in-part of application No. 12/352,619, filed on Jan. 13, 2009, now abandoned.

(51) Int. Cl. G05B 11/01

(52) U.S. Cl. 700/16

(57) ABSTRACT

A coding apparatus provided as a dedicated coding unit which enables digital presentation of analog process data, such as temperature, voltage, current, pressure, speed, velocity, radiation, vibration, and noise. The individual data controller feeding the coding unit operates based on a digital Discrete Economic Modulation (DEM) principle, which is a general method introduced for averaging within a special behavioristic control loop and provides coherent, flexible data for monitoring, on-line decision making and discrete optimization using classic procedures such as regression and the simplex method. The raw data input is converted in accordance with the DEM method, averaged four times a day, to provide four mean numbers per calendar day or one number a day for each 6-hour data file, as four time history files for coherent and flexible analysis without time lag and PC-oriented processing, as a standard protocol model for data highway networks.

### CROSS-REFERENCE TO RELATED PATENT

The present application is related to two previously issued patents by the same inventor, U.S. Pat. No. 5,515,288, issued May 7, 1996, entitled METHOD AND CONTROL APPARATUS FOR GENERATING ANALOG RECURRENT SIGNAL SECURITY FEEDBACK, and U.S. Pat. No. 5,732,193, issued Mar. 24, 1998, entitled METHOD AND APPARATUS FOR BEHAVIORISTIC-FORMAT CODING OF QUANTITATIVE RESOURCE DATA/DISTRIBUTED AUTOMATION PROTOCOL”, the disclosures of which are incorporated herein by reference.

### FIELD OF THE INVENTION

The present invention relates to information technology and management including instrumentation and data presentation methods and apparatus, and more specifically, to apparatus which provides time history files containing measured, stable, recurrent analog process data (e.g., temperature, voltage, pressure, speed, radiation, vibration, etc.), within predetermined periods, using a digital discrete economic modulation (DEM) principle, relating to a specific behavioristic control loop. This is the final work for my EWIT invention (“electronic wheel” information technology)—a full digital automatic system, completely operational without requiring a “human factor”. Bill Gates (founder of Microsoft) said: “normal computers can't deal with the numbers” (Time, 13 Feb. 2006, vol. 167, n. 7, p. 11). The present invention utilizes logical microprocessors which deal with the numbers. The present invention converts analog processes into numbers.

### BACKGROUND OF THE INVENTION

The basic functions of conventional up-to-date measured analog data process in metric practice (SI basic and derived units) usually are:

1) to sample and evaluate raw input values from sensors measuring process variables, and

2) to calculate current process conditions of a controlled device activity.

An example is the latest microprocessor-based transformer monitoring system, commercially available from Manometerfabric, Stockholm, Sweden, and sold under the trade name “Trafo Guard” (Bulletin TG1, 1991), which features advanced output and information printout format with true temperature points. Other examples are new multi-task signal analyzers/data loggers with high accuracy and great hardware possibilities, but traditional static output.

Even though there is a wide gap between up-to-date sophisticated instrumentation having high parametric accuracy, and out-of-date practices in metric analysis using static data presentation, metrology software is becoming an increasingly important tool of analysis.

Advanced steady-state data transducers (Telog, RIS, Metrosonics, etc.) provide the same raw data output, which must, however, be further processed on the PC. Up to now, stochastic information obtained by conventional or advanced data control apparatus has not provided any direct and coded data for making a controlled manufacturing process/product more efficient and productive using measured process variables for flexible analysis and decision making. This is a critical point. For instance, making a decision on improvements in a design or its performance usually requires an additional time-consuming, uncertain and expensive statistical process control/research involving the “human factor” (PC-oriented data processing). It is known—that for such research, a time history file of the process, with projection of averaging data on specific time intervals, is always required.

As mentioned above, the current approach to analog process data management/monitoring involves centralized data processing, with data presentation in various formats, which are either too flexible or completely static.

The centralized data processing and static data presentation approaches place time-lag and operational limitations on the effectiveness of standard data management, using real-time object-oriented data processing and a general communication interface (protocol).

It would therefore be desirable to provide an analog process data acquisition and coding system to maximize and communicate the economic usefulness of data processing and programming for fast and certain digital discrete optimization of the manufacturing process/product/service activity, using a compatible communication interface.

### SUMMARY OF THE INVENTION

Accordingly, it is a principal object of the present invention to overcome the above-mentioned conceptual disadvantages and to provide a coding apparatus and method for behavioristic-format coding of analog resource data for automatic process control, planning and communication purposes by utilizing:

1) a dedicated, individually measured analog signal presentation based on general standard software, using stochastic dynamics of the process, and

2) a general communication interface/protocol.

Thus, in accordance with a preferred embodiment of the present invention, a coding apparatus is provided for acquisition/presentation of analog process data comprising:

timing means for defining a plurality of time intervals corresponding to portions of a fixed time period;

means for averaging the input of qualitative analog process raw data provided by an analog data process input means;

storage means for storing said averaged input analog process data in accordance with said defined time intervals, as time history files; and

means for displaying said stored averaged input analog process data in said time history files,

The inventive coding apparatus can be provided as a dedicated/distributed coding unit enabling a coherent, unified, integrated protocol in recurrent analog process data presentation for discrete optimization purposes. The inventive coding apparatus operates within the standard tolerance ratings of the existing parametric range of the process data.

As a microprocessor-based controller, the apparatus utilizes conventional hardware blocks in combination with common control commands according to the ANSI/IEEE Std. 488-87 (time-schedule controller, two-level timer, A/D converter, buffer-storage, printing/record/transmitting modules) which is used for the dedicated individual, but general, standard software digital code embodiment. The inventive apparatus operates according to a DEM (Discrete Economic Modulation) principle within the analog data acquisition subsystem where raw data are periodically sampled and crop-coded in a digital format through a conventional A/D converter via a two-level timer. The data is then distributed in disjoint buffer-storage cells via averaging and digital display means to present, for each cell, one number a day.

The coding apparatus can be connected to all sensors or metering instruments in the stochastic process and provides totally distributed, group coding of standard raw data in non-fashion. The result is a new digital standard protocol model of DEM digital coded data.

The basic DEM principle introduced herein provides a special behavioristic control loop, by providing, within each calendar day, stochastic process decomposition and, accordingly, a disjoint, digital averaging means for converting original valid raw data via a standard sample, which is presented herein for any stable low-frequency recurrent (economic) stochastic process.

The profound difference of the DEM principle from classic control theory, wherein lies its novelty, is in its disregard for the noise problem within the behavioristic control loop. The DEM principle provides a full economic treatment of a recurrent stochastic low-frequency signal, by providing a significant mean (mathematical expectation) and non-significant random fluctuation (noise). This is the fundamental basis of the DEM principle, which distinguishes it from other well-known methods of analog signal modulation, including PCM (pulse code modulation).

The DEM principle digital parameters are:

1) 6: A standard 6-minute interval between each measurement of the original signal. This provides a sample takeoff probe. Using a standard digital parameter provides a recurrent low-frequency random process pulse—10 probes an hour;

2) 4×6: four 6-hour time history files per calendar day are presented in a digital—rectangular matrix, standard format. Thus, the DEM principle provides a behavioristic control loop for process signal analysis with a communication interface logic record.

The next standard digital parameter is provided by 6-hour averaging of data in a standard stochastic interval/half-period, providing 60 probes within every 6-hour time history file to convert every 60 probes into one number for presentation: four numbers per calendar day (e.g. for each 6-hour data file there are 7 numbers a week, . . . 365 numbers a year). An average 6-hour discrete decomposition (four process intervals) provides a time-independent/stationary approximation (close to Gaussian distribution) on every one of four intervals/half-periods.

With the DEM principle standard software approach, simple and correct processing/presentation of data is achieved, in accordance with the present invention; thus, a simple digital form of any recurrent analog process treatment in economic application is realized: four numbers per calendar day.

The four time history files may be represented by four colored areas, which correspond to the four numbers on each calendar day, and can be printed as data output. The data output is ready for on-line local and strategic decision-making and for discrete optimization programming in a standard digital format/time history protocol.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 illustrates a sampled analog signal in a data acquisition subsystem, useful as an example in describing a DEM (Discrete Economic Modulation) principle in accordance with the present invention;

FIG. 2 is a block-diagram of a preferred microprocessor-based embodiment of an analog resource data coding apparatus for processing variable analog parameters (such as temperature, voltage, pressure, speed, radiation, and vibration, etc.), constructed and operated in accordance with the principles of the present invention;

FIG. 3 is a rectangular matrix data printout, in digital format, representing time history data files provided as the coding apparatus output;

FIG. 4 is a schematic illustration of a business unit information system cycle using the DEM principle for standard flexible analog output data provided by the coding apparatus;

FIG. 5 is a schematic diagram illustrating a long-distance HV (high-voltage) electrical energy system, to which the inventive method can be applied in an application for transmission loss minimization via process control automation,

FIGS. 6A-D are graphs representing the voltage level measured during each of four daily load demand intervals related to peak power in the transmission system; and

FIG. 7 is a software flowchart representing an algorithm for voltage level monitoring and automatic HV circuit breaker control to achieve transmission loss minimization.

### DETAILED DESCRIPTION OF A PREFERRED EMBODIMENT

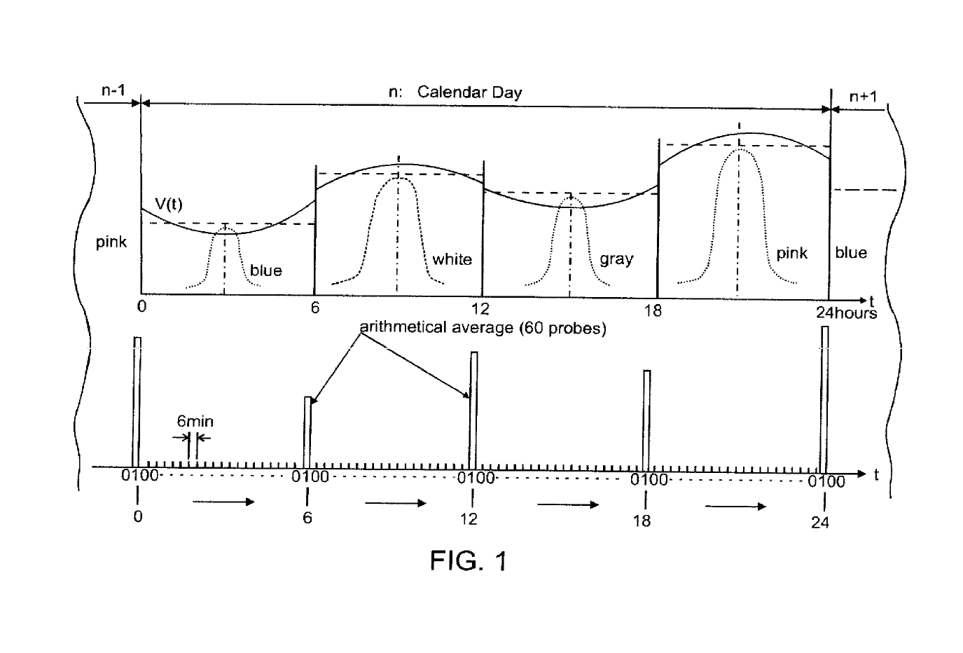

FIG. 1 shows a sampled analog signal in a data acquisition subsystem, useful as an example in describing a DEM (Discrete Economic Modulation) principle in accordance with the present invention. The analog signal V(t) is representative of a process variable which is taken from a control loop cycle during a calendar day.

The DEM principle is based on:

1) discrete averaging of analog data to provide four mean values as an adequate numerical image for an essentially time-dependent stochastic process, a day/two-period behavioristic control loop cycle and its adequate presentation in disjoint fashion; that is, one mean/number for each 6-hour half-period/segment: see related patent (page 1).

2) an approximation, introduced here, which means that each 6-hour stochastic interval of the stable recurrent analog process is close to Gaussian distribution.

The signal V(t) is a typical formalized two-period curve within a standard tolerance range, which is associated with four discrete half-periods within the behavioristic control loop cycle for such an analog signal. Each half-period has one saddle point, that enables optimization of each half-period separately. This approach flows from the DEM principle (see FIG. 1). The classic control theory subject of process noise (up to spectral filtration, etc.), is not within the scope of the DEM principle, which is concerned with the mathematical expectation (mean) only.

In accordance with the present invention, the averaging process begins and ends four times a day with a 6-minute elementary “pulse” interval using 60 probes, which are converted and averaged as digital values (M), providing one number for every 6-hour stochastic interval: 00.01-06.00 (blue); 06.01-12.00 (white); 12.01-18.00 (gray); 18.01-24.00 (pink) within the behavioristic control loop cycle or four numbers, only, each calendar day.

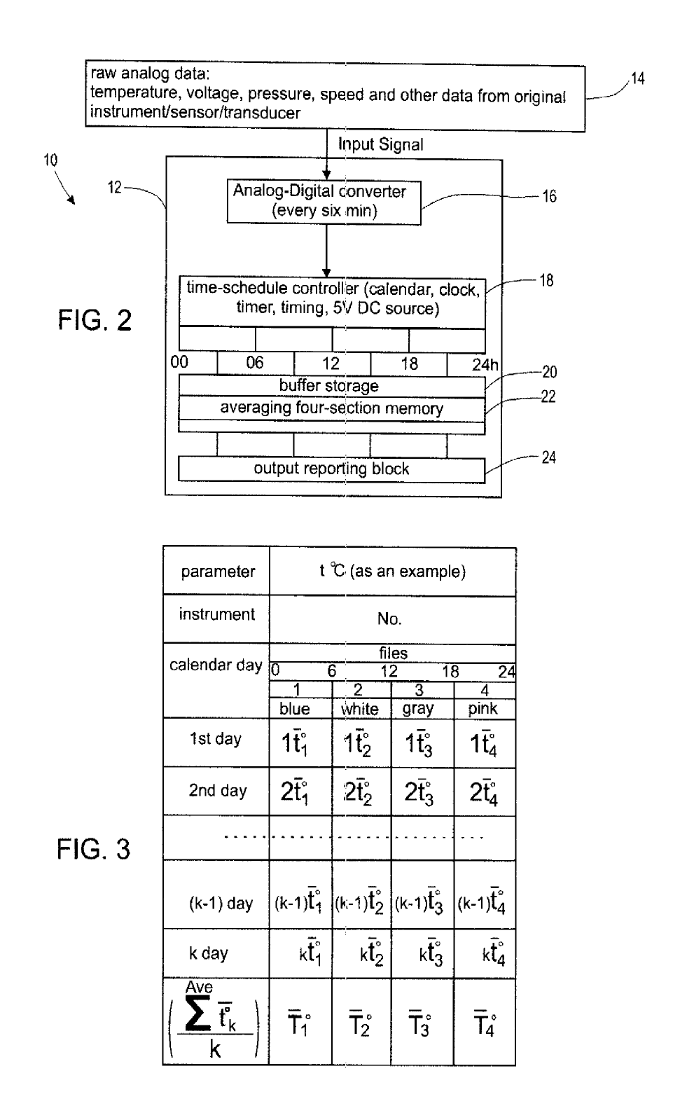

FIG. 2 is a block-diagram of a preferred embodiment of a coding apparatus 10 for digital processing of variable analog parameters, constructed and operated in accordance with the principles of the present invention. Coding apparatus 10 comprises a data acquisition unit 12 which is functionally connected to a primary instrumentation unit 14 comprising a stationary or portable analog data sensor/measuring instrument, by means of electrical, electronic, optic, or any other short-distance transmission carrier which is capable of transferring data with acceptable accuracy (input signal distance). The raw analog data itself can be presented, for example, by International SI basic and derived units, such as temperature, electricity (V, A) pressure (atm, bar), speed (m/sec), rotational velocity (rev/sec), vibration (Hz), noise (dB), etc.

The raw analog data is fed from primary instrumentation unit 14 to data acquisition unit 12, and is converted by an A/D converter 16 with a standard six-minute sample interval into digital signals (representing economic pulses in accordance with the DEM principle). The digital signals are then fed into a time-schedule controller 18, comprising a calendar, two-level timers for determining six-minute and six-hour time intervals, timing/synchronizing circuitry, and a 5 VDC independent power supply source.

The controller 18 distributes the raw digital data into the buffer storage block 20 for every 60 probes, which are averaged in a stochastic interval/half-period according to the DEM principle (by analog signal averaging and general behavioristic control loop cycle decomposition) as per FIG. 1. The behavioristic time intervals constitute a digital rectangular matrix format.

The rectangular matrix output data record during every predetermined 6-hour interval produces one of the four time history files as per FIG. 1:

00:01-06:00 (night/blue);

06:01-12:00 (morning/white);

12:01-18:00 (day/gray); and

18:01-24:00 (evening/pink)

The stored day-by-day digital data in the averaging four-section memory block 22 is four arithmetic mean/numbers a day, or one number a day in each time history file. These four time history files are ready for on-line decision making, or fast real-time object-oriented optimization programming procedures.

The time sequence of operation of coding apparatus 10 is as follows. The raw analog input signal is fed from primary instrumentation unit 14 to A/D converter 16 every six minutes and then is distributed via time schedule controller 18, averaged every six hours a day, and stored in the buffer-storage block 20 which feeds averaging four-section memory block 22. In this way, four subdivided files are created wherein each number is an arithmetic mean of sixty measured (every six minutes) sequential raw analog signal probes in every day's 6-hour data file (rectangular matrix order format). The four time history files may be printed or marked in different paper colors to avoid identification error, e.g blue, white, gray and pink.

Block 24 is an output reporting module that can be implemented as a printer/disk drive/communication transmitter unit in one output module.

Thus, the method and coding apparatus are realized according to the DEM principle, as introduced here, using standard software for digital parameter processing.

FIG. 3 shows the data printout in rectangular matrix format representing (in colored digital display the four time history files as the result of the coding apparatus 10 operation in accordance with the DEM principle. The format represents a 4-group coded digital data rectangular matrix, available in printed or record form, for local or strategic fast and certain decision-making in a stable, recurrent, economic analog process, for use with discrete, real-time object-oriented optimization programming procedures.

The proposed method and coding apparatus is compatible with the main features of OSI layers (ISO), ASCII and ISDN: standardization, flexibility, compatibility, and integration, in order to provide access for a bi-directional data highway network.

As will be understood by those skilled in the art, the coding apparatus 10 may be modified by elimination of possible invalid input signals, if their random magnitudes are beyond a valid signal range, e.g., up to +/−50%, instead of +/−10%.

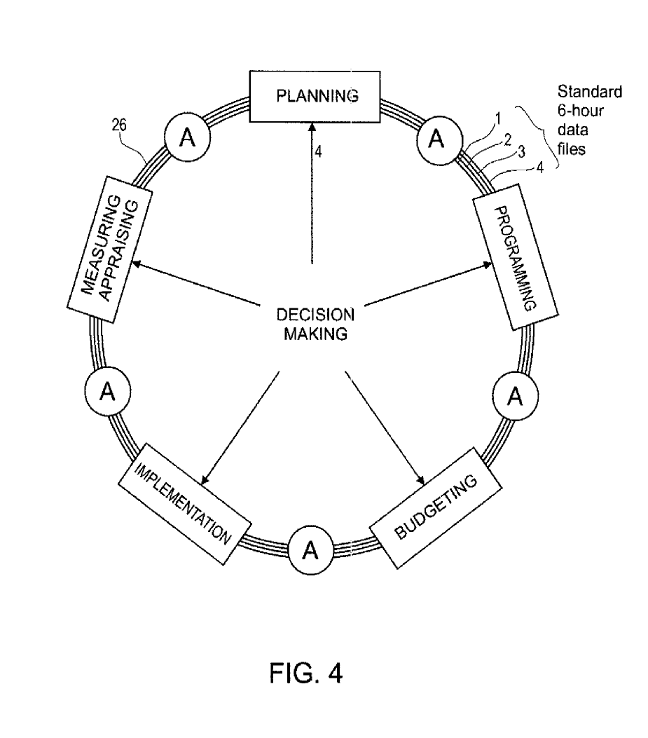

In FIG. 4, there is shown a schematic illustration of a business unit information system cycle using the DEM principle. The system uses standard flexible analog output data, as a standard protocol model containing four time history files as, provided by coding apparatus 10. This approach may include the use of a data highway 26 on which qualitative analog data is transferable to various computer stations “A” for technological process analyses and decision-making. These analyses are related to planning/forecasting/budgeting/programming activities in accordance with the DEM principle.

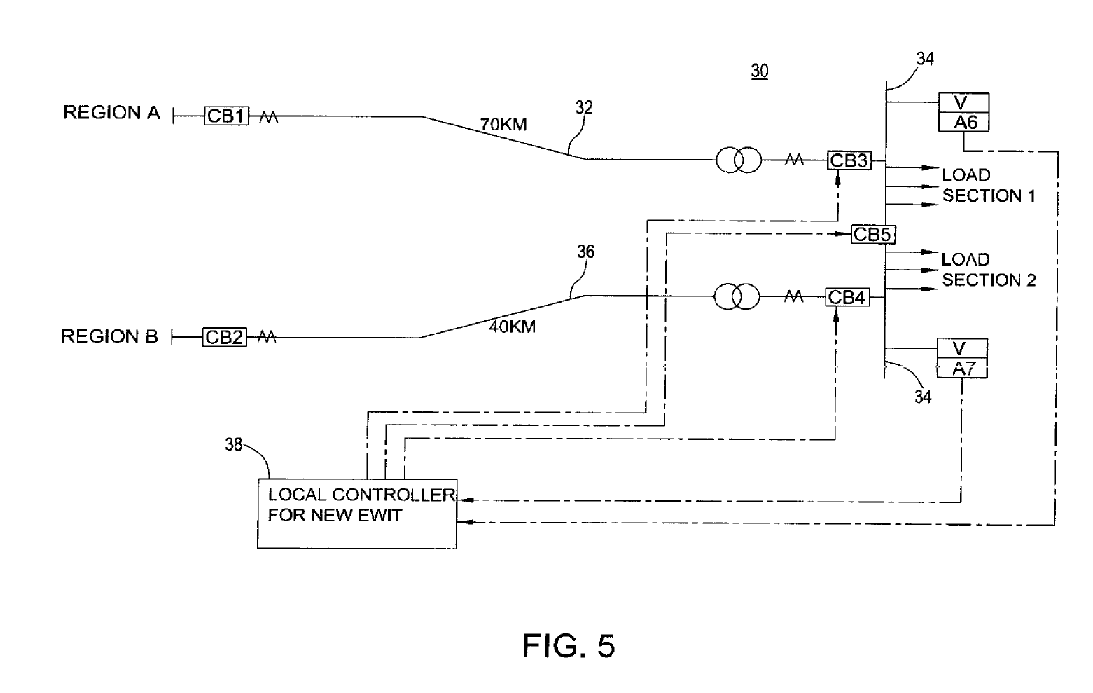

In FIG. 5, there is shown a schematic diagram illustrating a long-distance HV electrical energy system 30, to which the inventive coding apparatus 10 may be applied in an application for transmission loss minimization via process control automation.

This example of energy transmission losses represents the classic problem of HV public utilities management. Indeed, this problem costs the US power industry no less than 3% of sales (approx. $5.5 billion annually). “The amount of energy lost in transmission of electricity from one location to the other is so large as to make long-distance transport extremely inefficient”, Earth in the Balance, Al Gore, Houghton-Mifflin (1992), p. 330.

In current practice, this problem has not been adequately solved because of the software gap resulting from the impossibility of simultaneous and coherent comparison of metering data collected from final long-distance control points (Kw hours and voltage level) having automatic breakers, and performing this data comparison within coherent load intervals such as peak-peak, off-peak—off-peak, etc.

There are two parameters which can be measured by metering data for this problem solution:

1) the first parameter is Kw hrs. as quantitative resource data (refer to FIG. 10A of my previous U.S. Pat. No. 5,732,193, at col. 12, line 34; and

2) the second parameter is voltage level as analog data, per the description of the present patent application.

In FIG. 5, a transmission line from Region A is connected via circuit breaker CB1 and transmits power over a 70 Km line 32 through CB3 to a distribution voltage bus 34. Distribution bus 34 connects Load Section 1 and Load Section 2 via circuit breaker CB5.

In similar fashion, a transmission line from Region B is connected via circuit breaker CB2 and transmits power over a 40 Km line 32 through CB4 to distribution voltage bus 34. Voltage control according to the DEM principle acts via a local controller 38, two bus voltmeters (V) with associated microprocessor controllers (A6, A7), and operation of the HV circuit breakers CB1, CB2, CB3, CB4, and CB5.

For example, a possible solution to minimize losses in the HV system 30 of FIG. 5, on a given day is:

| | |
|---|---|
| Blue (off-peak) interval | Breakers CB1, CB2, CB3, CB4 are |
| 00-06 hrs. | closed and CB5 is in open position; |
| White (morning-peak) interval | Breakers CB2, CB4 and CB5 are closed |
| 06-12 hrs. | and CB1, CB3 are in open position; |
| Gray (mid-peak) interval | Breakers CB1, CB3 and CB5 are closed |
| 12-18 hrs. | and CB2, CB4 are in open position; |
| Pink (peak) interval | Breakers CB1, CB2, CB3, CB4 are |
| 18-24 hrs. | closed and CB5 is in open position. |

The status of breakers CB1-CB5 and their associated operating positions (open or closed) depends on different lengths of two HV lines: the 70 Km line 32 and the 40 Km line 36 (see FIG. 5).

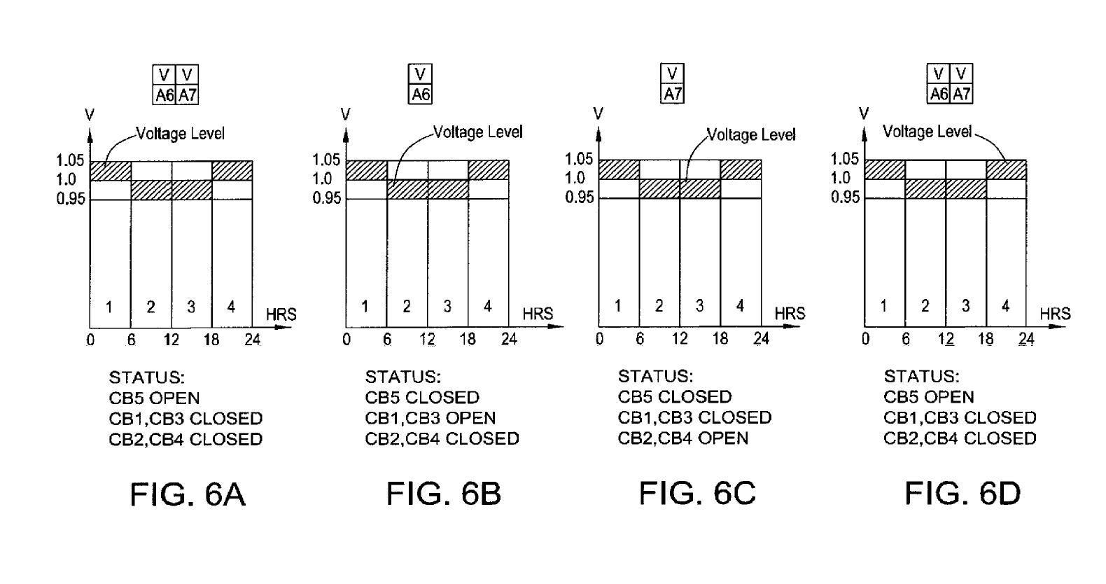

This status of the breakers CB1-CB5 is also reflected in the graph of FIGS. 6A-D showing the voltage level within a standard voltage range between 0.95-1.05 of nominal value. For example, in FIG. 6A, where CB5 is open during the Blue (off-peak) interval, the individual HV lines 32 and 36 each provide power to their respective Load Sections, so that HV line 32 provides power to Load Section 1 and HV line 36 provides power to Load Section 2. In this case, both voltmeters V and their associated microprocessors A6, A7 measure the voltage level as within the 0.95-1.05 range of nominal value.

In FIG. 6B, where CB5 is closed during the White (morning-peak) interval, the 40 Km line 36 provides power to both Load Section 1 and Load Section 2 via CB2 and CB4, there is a possibility that voltmeter V and its associated microcontroller A6 will measure the voltage level as too low below the nominal value.

As shown in FIG. 6C, where CB5 is closed during the Gray (mid-peak) interval, the 70 Km line 32 provides power to both Load Section 1 and Load Section 2 via CB1 and CB3, there is a possibility that voltmeter V and its associated microprocessor A7 will measure the voltage level as too low below the nominal value.

Finally, in FIG. 6D, where CB5 is open during the Pink (peak) interval, the individual HV lines 32 and 36 again each provide power to their respective Load Sections, so that HV line 32 provides power to Load Section 1 and HV line 36 provides power to Load Section 2. Again, both voltmeters V and their associated microprocessors A6, A7 measure the voltage level as within the 0.95-1.05 range of nominal value.

The adjustment of the status of the breakers CB1-CB5 can be made to depend upon the decisions of the utility operations duty staff during the different intervals, or it can be fully automated using control signals for the HV circuit breakers. The control signals will be generated based on the design of a microprocessor-based automated system operating in local controller 38 in accordance with an algorithm which monitors the voltage level and converts measurements of the voltage level into input analog data for the coding apparatus 10.

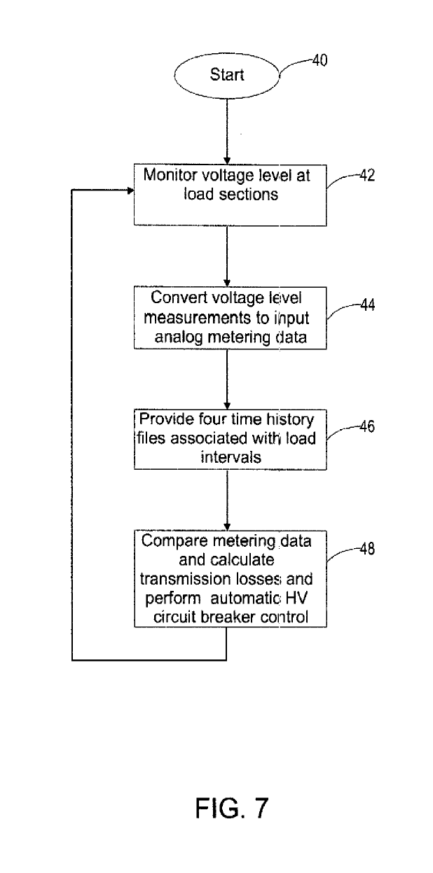

In FIG. 7, there is shown a software flowchart representing an algorithm for voltage level monitoring and automatic HV circuit breaker control to achieve transmission loss minimization. In start block 40, the system is initialized, and in block 42, the voltage level is monitored at the load sections. In block 44, voltage level measurements at distribution bus 34 are converted by microprocessor controllers A6, A7 to input analog metering data and fed to coding apparatus 10 (see FIG. 2). In block 44, the coding apparatus 10 provides four time history files associated with the load intervals, and in block 46 the comparison of metering data in the time history files and calculation of the transmission losses enables performance of automatic HV circuit breaker control to achieve transmission loss minimization.

The application of this elegant engineering automatic management solution can be achieved in many other industries where resources are transmitted over long distance and primary metering data is available via microprocessor controllers such as in the case of gas, liquid fuel, water, chemical matter, etc.

As will be understood by those skilled in the art, the solution has favorable environmental and ecological consequences, since it reduces the waste of resources.

Having described the invention with regard to certain specific embodiments thereof, it is to be understood that the description is not meant as a limitation, since further modifications may now become apparent to those skilled in the art, and it is intended to cover such modifications as fall within the appended claims.

I claim:

1. A method for periodically, automatically controlling a process in accordance with digital control signals produced as output by a non-programmable controller, wherein the non-programmable controller is responsive to behavioristic-format coded input data supplied by a non-programmable coding apparatus which acquires raw, analog resource data measured by primary instrumentation, said method comprising the steps of:
defining, in said coding apparatus, four 6-hour time intervals corresponding to periods of a 24-hour calendar day;
inputting the instrumentation-measured raw, analog resource data as discrete digital values into a summing means in said coding apparatus;
disjointly summing said discrete digital values of the raw, instrumentation-measured analog resource data occurring during said intervals;
storing said summed discrete digital values of analog resource data associated with each of said defined four 6-hour time intervals, as four digital-coded numbers a day;
providing said four digital-coded numbers to said controller for producing, via arithmetic and logic manipulation, said digital control signals; and
performing periodic automatic process control in accordance with said digital control signals,
wherein said storing step is performed by subdividing the calendar day to produce said four digital-coded numbers, each associated with one of four daily intervals defined by the following hourly intervals:

| | |
|---|---|
| 00:01-06:00 | (night); |
| 06:01-12:00 | (morning); |
| 12:01-18:00 | (day); and |
| 18:01-24:00 | (evening); |

and wherein said four digital-coded numbers comprise a rectangular matrix, each digital-coded number corresponding to one of said four 6-hour daily intervals, said rectangular matrix defining a standard analytical format for process control and object-oriented linear programming and regression optimization procedures.

2. The method of claim 1 wherein said rectangular matrix provides a matrix game billing format for two-sided supply and demand decision-making applied to energy consumption optimization, providing commercial equilibrium billing format realization.

3. The method of claim 1 wherein said digital-coded numbers are applied to electrical energy transmission loss minimization in accordance with a method comprising the steps of:
comparing a first and second voltage level over a 6-hour interval, said first voltage level being associated with a first transmission line, and said second voltage level being associated with a second transmission line:
calculating simultaneous, coherent losses associated with each of said first and second voltage levels;
comparing said calculated losses at the end of said 6-hour interval: and
disconnecting one of said first and second transmission lines,
wherein said first transmission line is disconnected if said losses associated with said first voltage level exceed said losses associated with said second voltage level, and
wherein said second transmission line is disconnected if said losses associated with said second voltage level exceed said losses associated with said first voltage level.

4. The method of claim 1 further comprising the step of providing said digital-coded numbers for printing said stored, discrete summed analog resource data in four colors.

5. The method of claim 1 further comprising the step of transferring said digital-coded numbers containing said discrete, summed digital values of analog resource data over a data highway in a distributed automation protocol to at least one computing station for performing automatic process control, discrete optimization and decision-making.

6. The method of claim 1 wherein said step of providing said digital-coded numbers for producing said digital control signals comprises arithimetic and logic manipulation including summing, subdividing, multiplying, and comparing steps.

7. A dedicated non-programmable coding apparatus for providing behavioristic-format coded output data using input raw, analog resource data measured by primary instrumentation, said apparatus comprising:
timing means for defining four 6-hour time intervals corresponding to periods of a 24-hour calendar day;
summing means for disjointly summing discrete digital values of the raw, instrumentation-measured analog resource data occurring during said time intervals;
storage means for storing said summed discrete digital values of analog resource data associated with each of said defined four 6-hour time intervals, as four digital-coded numbers; and
means for transferring said digital-coded numbers as time history files containing said discrete, summed digital values of analog resource data over a data highway in a distributed automation protocol to at least one computing station for performing periodic, automatic process control, discrete optimization and decision-making,
wherein said timing means subdivides the calendar day to produce said four digital-coded numbers, each associated with one of four daily intervals defined by the following hourly intervals:

| | |
|---|---|
| 00:01-06:00 | (night); |
| 06:01-12:00 | (morning); |
| 12:01-18:00 | (day); and |
| 18:01-24:00 | (evening); |

and wherein said four digital-coded numbers comprise a rectangular matrix, each digital-coded number corresponding to one of said four 6-hour daily intervals, said rectangular matrix defining a standard analytical format for process control and object-oriented linear programming and regression optimization procedures.

8. The coding apparatus of claim 7 wherein said four digital-coded numbers comprise a rectangular matrix containing four group coded values each corresponding to one of said four 6-hour daily intervals, said rectangular matrix defining a standard format for process control automation and object-oriented linear programming and regression optimization procedures.

9. The coding apparatus of claim 7 further comprising means for color-format printing of said time history files.

10. The coding apparatus of claim 7 wherein said analog resource data is provided by the primary instrumentation in digital form.

11. The coding apparatus of claim 7 wherein said timing means, summing means and storage means compromise a microprocessor-based analog resource data controller.

12. A dedicated nonprogrammable coding apparatus for automatically coding measured analog resource data provided by primary instrumentation, said apparatus comprising:
timing means for defining four 6-hour time intervals corresponding to periods of a 24-hour calendar day;
summing means for disjointly summing discrete digital values of the raw, instrumentation-measured analog resource data occurring during said time intervals;
storage means for storing said summed discrete digital values of analog resource data associated with each of said defined four 6-hour time intervals, as four time history files; and
means for color-format printing said stored, summed discrete digital values of analog resource data in said associated one of said four time history files,
wherein said four time history files comprise a rectangular matrix containing four group coded values corresponding to said four 6-hour daily intervals, said rectangular matrix defining a standard format for periodic process control automation and object-oriented linear programing and regression optimization procedures,
wherein said timing means subdivides the calendar day to produce said four digital-coded numbers, each associated with one of four daily intervals defined by the following hourly intervals:

| | |
|---|---|
| 00:01-06:00 | (night); |
| 06:01-12:00 | (morning); |
| 12:01-18:00 | (day); and |
| 18:01-24:00 | (evening); |

and wherein said four digital-coded numbers comprise a rectangular matrix, each digital-coded number corresponding to one of said four 6-hour daily intervals, said rectangular matrix defining a standard analytical format for process control and object-oriented linear programming and regression optimization procedures.
